(19) United States
(12) Patent Application Publication
(10) Pub. No.: US 2011/0057474 A1
(43) Pub. Date: Mar. 10, 2011

(54) ACCOMMODATION UNIT

(76) Inventor: Raymond Bruce Cunningham, Sydney (AU)

(21) Appl. No.: 12/871,573

(22) Filed: Aug. 30, 2010

Related U.S. Application Data
(60) Provisional application No. 61/240,040, filed on Sep. 4, 2009.

(51) Int. Cl. B60P 3/39

(52) U.S. Cl. 296/165

(57) ABSTRACT

A unit for providing accommodation on a vehicle including a structure defining an internal accommodation space and a utility module coupled via a lowering mechanism to the structure of the unit, the lowering mechanism adapted to transition the module between an elevated, stored position within the internal accommodation space and a lowered, in-use position outside of the internal accommodation space.

### BACKGROUND

1. Technical Field

This disclosure generally relates to accommodation units for use with tray back vehicles.

2. Description of the Related Art

Accommodation units carried on the rear of tray back or utility vehicles are an alternative to caravans and are particularly advantageous when it is desirable to use the vehicle to tow a boat or other type of trailer.

The size of an accommodation unit carried by a vehicle is often limited due to the width and/or height of the vehicle. Often the accommodation unit houses a kitchen or other utilities type module that is typically used when the vehicle is stationary at a camp-site.

### BRIEF SUMMARY

Embodiments described herein provide systems and methods for compactly storing a utility module, such as a kitchen module, within an accommodation unit during transit and enabling reconfiguration of the utility module to maximize the internal living space within the accommodation unit at a camp-site.

In accordance with various embodiments of the invention, there is provided a unit for providing accommodation on a vehicle including a utility module coupled via a lowering mechanism to the unit wherein the lowering mechanism is adapted to carry the module between an elevated, stored position within the unit and a lowered, in-use position outside of the unit.

In some embodiments, the unit further includes a side wall operatively coupled to the roof of the unit; wherein the side wall is movable between an open and closed position such that in the open position the side wall provides an opening on the side of the unit and forms an external roof thereby defining an annex.

In some embodiments, the side wall is formed of a dual panel wall, the dual panel wall further including a first panel hinged from the roof of the unit and a second panel coupled to the first panel; and wherein in the closed position the second panel is stored on the inside face of the first panel; and wherein in the open position the first panel is pivoted outwardly, forming an inner portion of the roof of the annex and the second panel is movable to form an outer portion, thereby extending the roof of the annex.

In some embodiments, the module within the unit is coupled to a motorized system of wire ropes and guide mechanism such that the module is able to maintain a substantially upright position whilst moving between the stored and in-use position.

In some embodiments, the module is in the form of a kitchen, bench, toilet or other utilities arrangement.

In some embodiments, the module additionally provides a structural support, such that a person is able to step on or into the module to access the unit.

In some embodiments, the unit further includes sockets configured to receive a jack extending from the ground, such that the unit may be elevated from the vehicle, allowing the vehicle and unit to be separated.

In some embodiments, the unit further includes a wind break pivotally coupled to the forward edge of a roof of the unit, the wind break being collapsed onto the roof of the unit when not in use.

### BRIEF DESCRIPTION OF THE SEVERAL VIEWS OF THE DRAWINGS

FIG. 1 is a side view of a unit mounted to a vehicle.

FIG. 2 is a top view of the unit and vehicle of FIG. 1.

FIG. 3 is a rear view of the unit and vehicle of FIG. 1, in the direction indicated by line 3-3 shown in FIG. 1.

FIG. 4 is a section view of the unit and vehicle of FIG. 1, along the line 4-4 shown in FIG. 1.

FIG. 5 is a section view of the unit and vehicle of FIG. 1, along the line 5-5 shown in FIG. 2.

FIG. 6 is a top view of the unit and vehicle of FIG. 1 with a side wall of the unit extended to form a roof of an annex.

FIG. 7 is a section view of the unit and vehicle of FIG. 6, along the line 7-7 shown in FIG. 6.

FIG. 8 is a section view of the unit and vehicle of FIG. 6, along the line 8-8 shown in FIG. 6.

FIGS. 9A, 9B and 9C illustrate a rear view sequence showing the module moving between the stored position and in-use position.

FIG. 10 is a plan view of a lowering mechanism of the unit of FIG. 1.

FIG. 11 is a partial enlarged view of the lowering mechanism of FIG. 10.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures associated with tray back vehicles and accommodation units may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

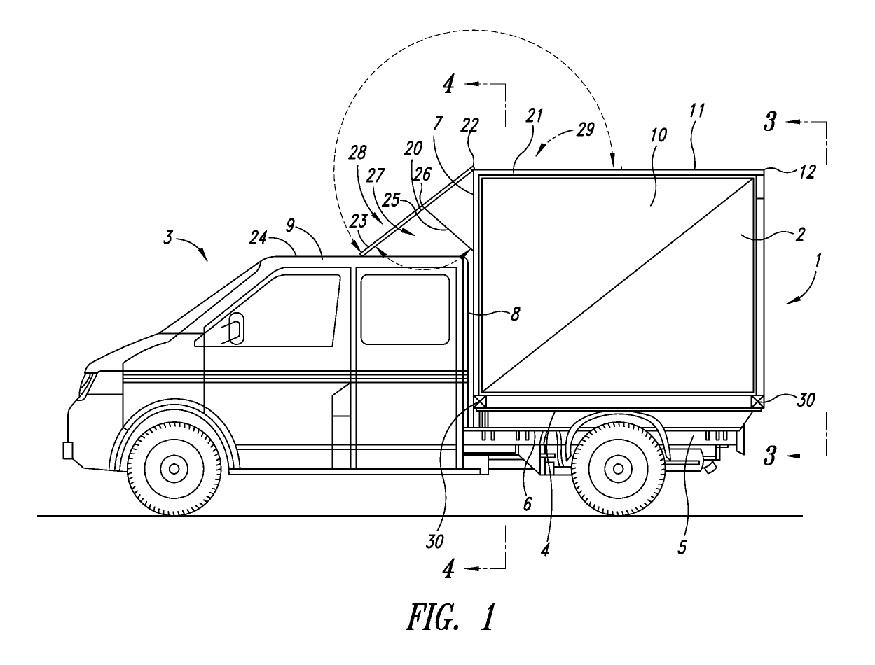

Referring to FIG. 1, there is illustrated a unit 1 having a structure which defines an internal accommodation space 2 seated on a transport vehicle 3. The unit 1 can be approximately cubic in shape and can have a flat, rectangular base 4 that is mounted to a chassis 5 or tray 6 of the vehicle 3. A front 7 of the unit 1 can be positioned immediately behind a rear 8 of a driver cab 9 of the vehicle 3. The unit 1 can include a dual panel side wall 10 that is pivotally coupled via a hinge 12 to a roof 11 of the unit 1 and may be pivoted outwardly from the unit 1.

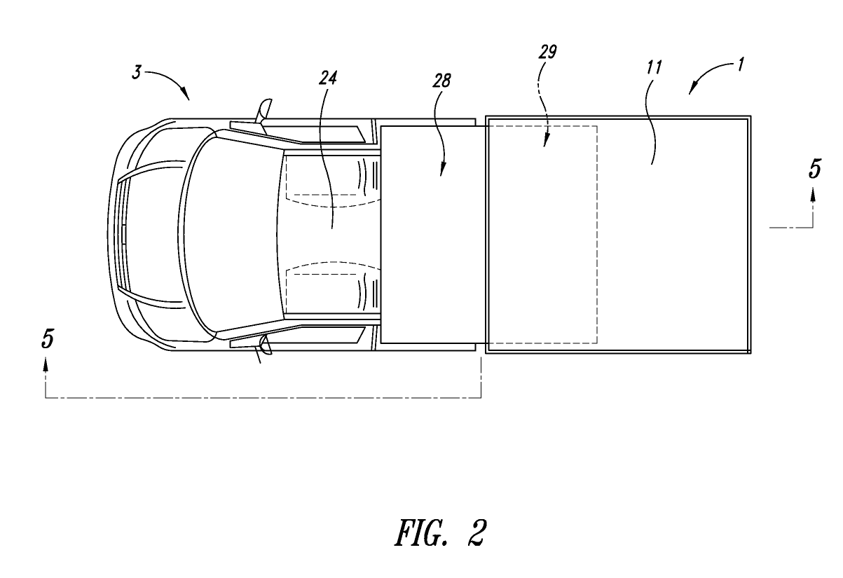

The roof 11 of the unit can include a wind deflector 20 pivotally coupled by a hinge 22 to a front 21 of the roof 11. The wind deflector 20 can also include a brace 25 that is pivotally coupled via a hinge 26 on the wind deflector 20. When in use, the illustrated wind deflector 20 is pivoted downwardly so that an end 23 of the wind deflector 20 is adjacent a roof 24 of the driver cab 9 providing a more aerodynamic profile of the transition between the roof 24 of the driver cab 9 and the roof 11 of the unit 1. In this position, the wind deflector 20 forms a triangular recess 27, that the brace 25 is hinged into, traversing the recess 27 providing support to and locking the wind deflector 20 in place. FIG. 2 illustrates the position of the wind deflector 20 in the lowered position 28 and stowed position 29.

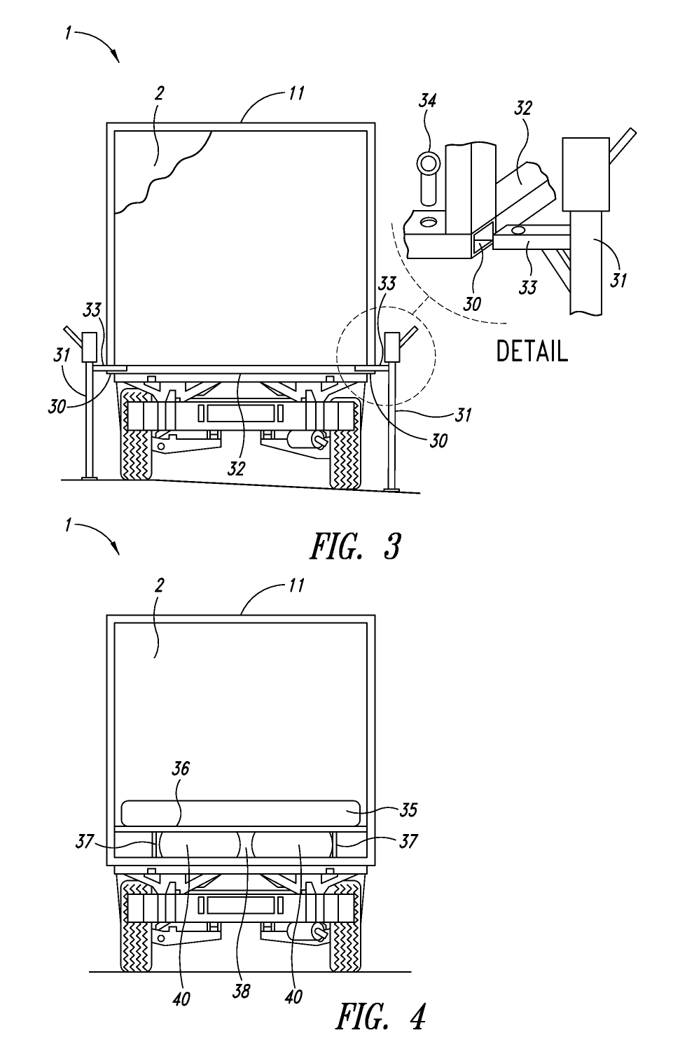

Referring now to FIG. 3, the base 4 of the unit 1 can include a frame 32 with a socket point 30 on each of the four corners. The socket points 30 can be coupled with hydraulic jacks 31 to elevate the base 4 thereby decoupling the unit 1 from the chassis 5 or tray 6 of the vehicle 3. To connect the jack 31, a horizontal member 33 at the top of the jack 31 may be inserted in the socket point 30 and locked in place by a locking pin 34. In this configuration, the jacks 31 provide support for the unit 1 allowing it to be free standing. To fully decouple the illustrated unit 1, the brace 25 of the wind deflector 20 should be unlocked and the wind deflector 20 pivoted about the hinge 22 so that it lies on top of and parallel to the roof 11 of the unit 1. Once the unit 1 is fully decoupled from the vehicle 3, the vehicle 3 may be removed.

Referring now to FIG. 4, the internal accommodation space 2 can include a bed 35 supported by a floor 36. In the illustrated embodiment, the floor 36 is offset from the base 4 by vertical supports 37 that define a cavity 38 between the floor 36 and the base 4. The cavity 38 may be used to house, among other things, water tanks 40 for providing a user with a supply of fresh water.

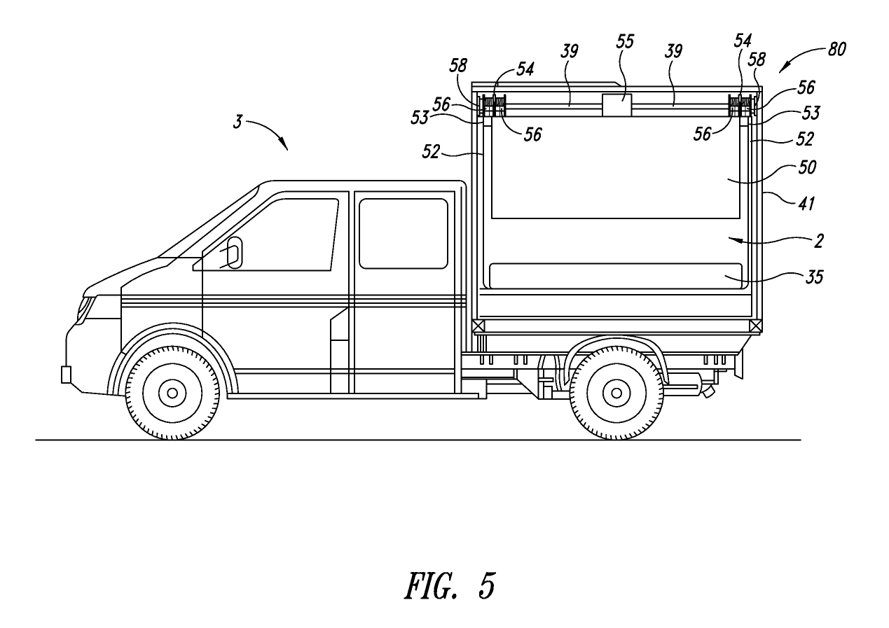

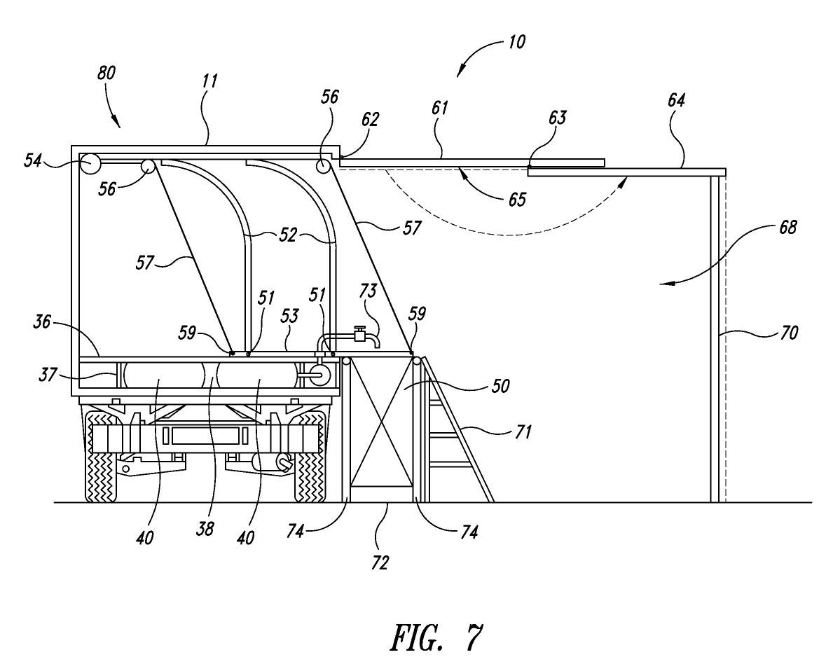

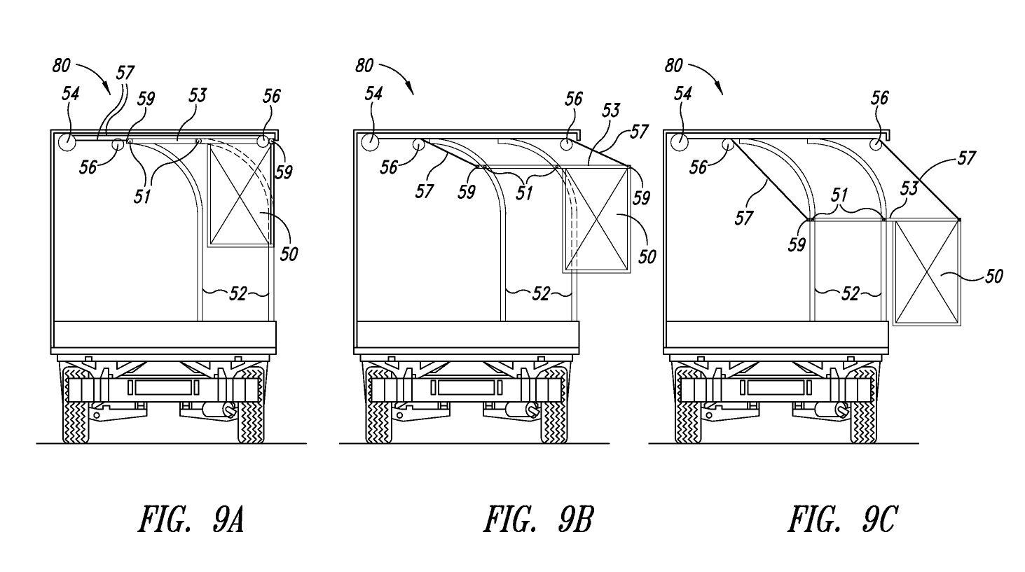

Referring now to FIG. 5, the accommodation space 2 houses a utility module, which may, for example, be provided in the form of a kitchen module 50. FIG. 5 shows the kitchen module 50 in the stowed position above the bed 35 suspended by a lowering mechanism 80. The illustrated kitchen module 50 is supported by wire ropes 57 (see FIG. 7) of the lowering mechanism 80 that are coupled to the accommodation unit 1 via a geared drive motor 55, drive pulleys 54 and bearings 58. The kitchen module 50 can be guided between the raised and lowered positions via two guide tracks 52 positioned on either side of the interior of the unit 1. The kitchen module 50 can include a connecting arm 53 or other structural member that is equipped with guide members, such as guide wheels 51 (FIGS. 7, 9A-C, 10 and 11), which align with and ride in corresponding channels or grooves of the guide tracks 52. The drive pulleys 54 are supported by the bearings 58 and are coupled to the drive motor 55 via drive shaft 39 to wind and unwind the wire ropes 57 from the drive pulleys 54 to raise and lower the kitchen module 50. The wire ropes 57 are connected via fasteners or other attachment means to the kitchen module 50 and connecting arms 53 at wire rope connections 59 (FIGS. 7, 9A-C, 10 and 11). Jockey pulleys 56 (FIGS. 7, 9A-C, 10 and 11) can be positioned between the drive pulleys 58 and the wire rope connections 59 to redirect the applied force of the wire ropes 57 to facilitate raising and lowering of the kitchen module 53 in an efficient manner.

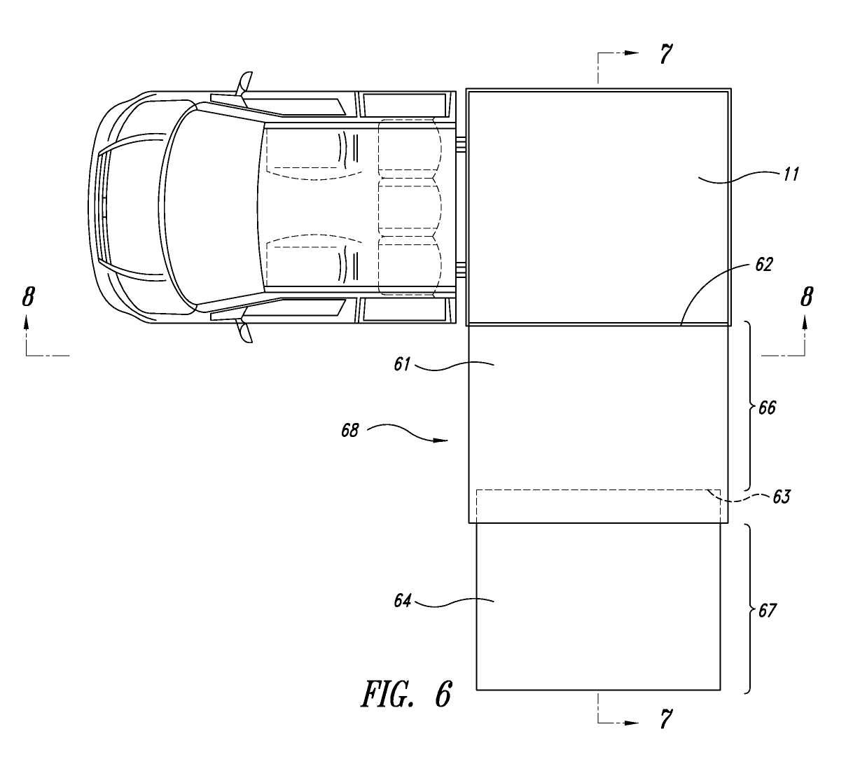

Referring now to the embodiment illustrated in FIG. 6, the dual panel side wall 10 includes a first panel 61 hinged via a hinge 62 from the roof 11 of the unit 1 and a second panel 64 hinged via a hinge 63 to the first panel 61. In the closed position, the second panel 64 can be stored on the inside face 65 (FIG. 7) of the first panel 61. In the open position as shown in FIGS. 6 and 7, the first panel 61 is located outwardly from the unit 1 to form an inner portion 66 of a roof of an annex 68 and the second panel 64 is located outwardly from the first panel 61 to form an outer portion 67, thereby extending the roof of the annex 68.

Referring now to FIG. 7, the dual panel side wall 10 is shown in a fully extended condition, with the roof 11, first panel 61 and second panel 64 substantially parallel and supported by telescopic poles 70. In FIG. 7 it can be seen that the kitchen module 50 has been lowered via the wire ropes 57 to the ground 72 beside the accommodation unit 1. When the dual panel side wall 10 is in this open position, the kitchen module 50 is able to be moved from a stored, elevated position as shown in FIG. 5 to a lowered, in-use position as shown in FIG. 7. As may be appreciated from FIG. 7, the height of the kitchen module 50, when resting on the ground 72, is approximately level with the floor 36 allowing a person to easily enter the accommodation space 2 via a ladder 71. The kitchen module 50 also includes adjustable legs 74 to adjust the height of the kitchen module and to take into account an uneven surface of the ground 72. In this configuration, the kitchen module 50 also provides support to the ladder 71 and any loading associated with entry and exit of the accommodation space 2 via the module 50. A swivel water spout 73 provides water from the tanks 40 to the kitchen module 50 that has an in-use position alongside the unit 1.

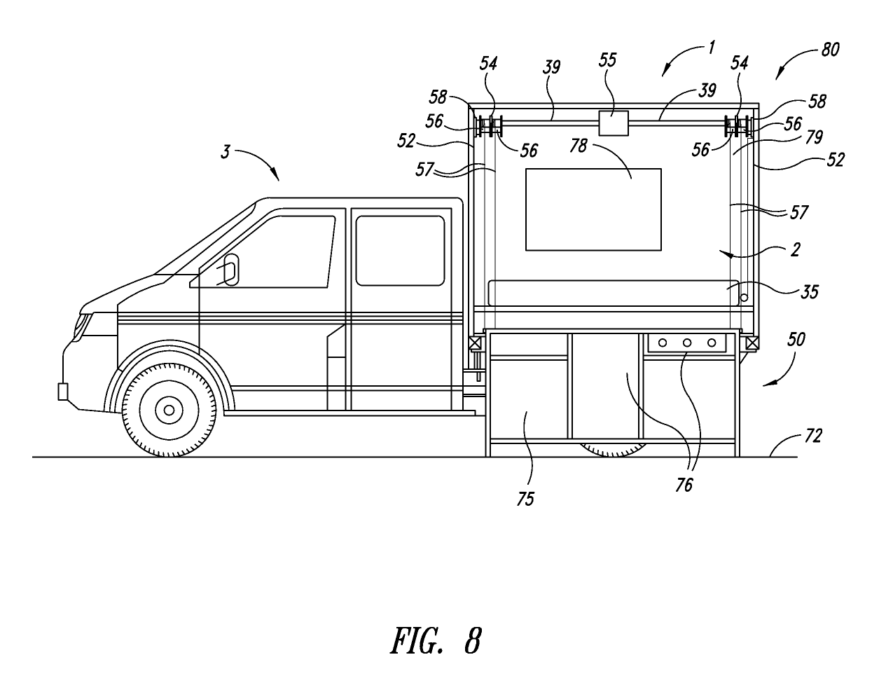

Referring now to FIG. 8, a side view of the unit 1 is shown with the kitchen module 50 in the lowered, in-use position. The kitchen module 50 is shown to include storage space 75 and kitchen appliances 76. The accommodation space 2 is also shown to include a window 78 on a side wall 79 opposite the dual panel side wall 10.

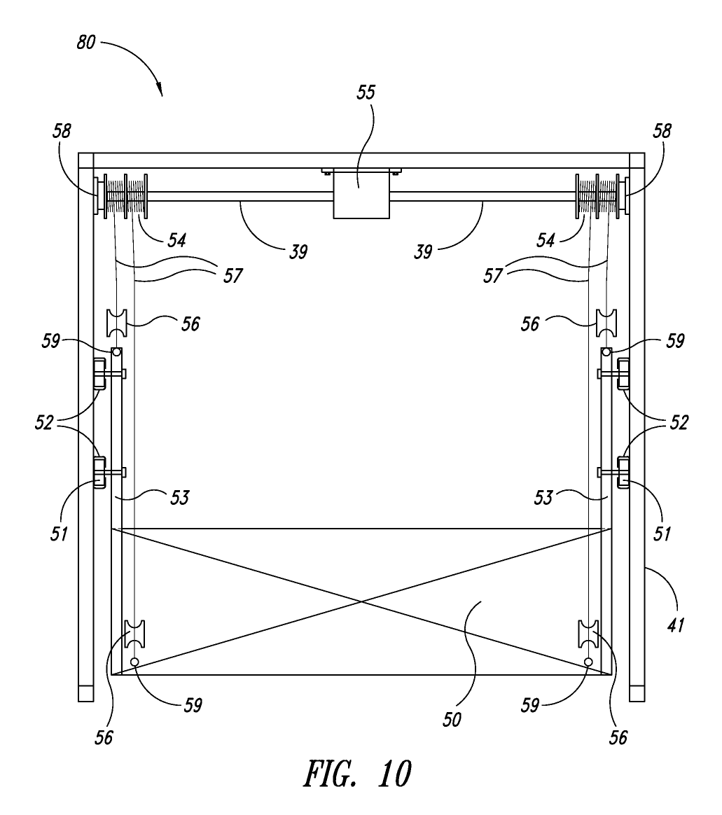

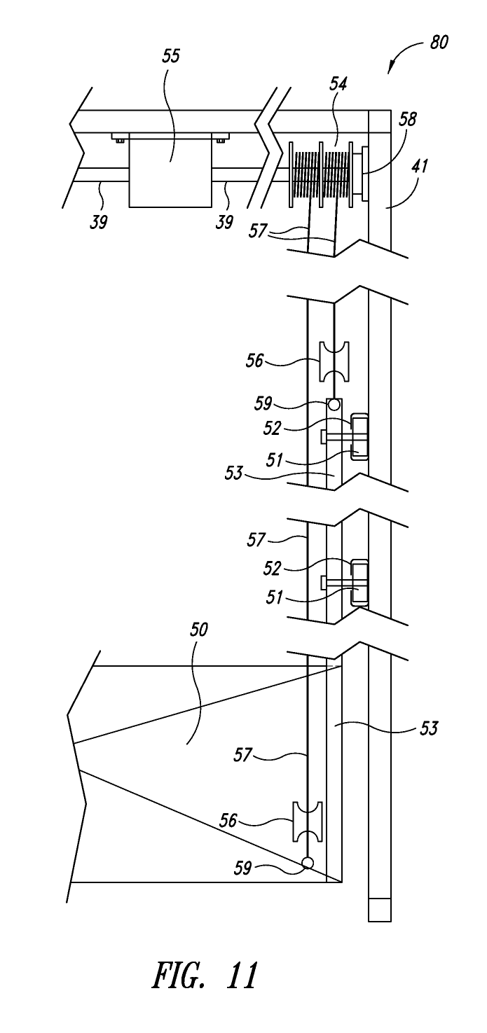

FIGS. 9A to 9C show stages of lowering the kitchen module 50, with the final lowered position shown in FIGS. 7-8. FIG. 10 illustrates a section top plan view of the unit 1 showing the positioning of various components of the lowering mechanism 80 according to one embodiment. FIG. 11 shows a partial enlarged section view of the components of the lowering mechanism 80 of FIG. 10 in further detail. These components can include the drive motor 55, drive shaft 39, drive pulleys 54, bearings 58, wire ropes 57, jockey pulleys 56 and guide tracks 52. Also shown are wire rope connections 59 for attaching the connecting arms 53 and kitchen module 50 to the wire ropes 57. Guide wheels 51 coupled to the connecting arms 53 of the kitchen module 50 are also illustrated. The guide wheels 51 ride in the guide tracks 52 of the lowering mechanism 80 which may be secured to the front and rear walls 41 of the unit 1. The lowering mechanism 80 may further include a switch (not shown) conveniently located for a user to activate the motor to selectively raise and lower the kitchen module 50, as illustrated best in FIGS. 9A-9C.

The invention has been described by way of non-limiting example only and many modifications and variations may be made thereto without departing from the spirit and scope of the invention described. For example, the various embodiments described above can be combined to provide further embodiments.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A unit for providing accommodation on a vehicle comprising:
a structure defining an internal accommodation space;
a utility module; and
a lowering mechanism coupled to both the structure and the utility module, the lowering mechanism adapted to carry the utility module between an elevated, stored position within the internal accommodation space and a lowered, in-use position outside the internal accommodation space.

2. The unit of claim 1 wherein the structure of the unit comprises a side wall and a roof, the side wall operatively coupled to the roof and movable between a closed position and an open position in which the side wall forms an external roof defining at least a portion of an annex that extends from a side of the unit.

3. The unit of claim 2 wherein the side wall is formed of a dual panel wall, the dual panel wall having a first panel hinged to the roof of the structure and a second panel coupled to the first panel such that in the closed position the second panel is stored on an inside face of the first panel and in the open position the first panel forms an inner portion of the external roof of the annex and the second panel forms an outer portion of the external roof, thereby extending the external roof of the annex.

4. The unit of claim 1 wherein the lowering mechanism comprises a system of wire ropes and guide tracks configured to raise and lower the utility module, the guide tracks positioned to guide the utility module outside the accommodation space when the utility module is lowered from the elevated, stored position to the lowered, in-use position.

5. The unit of claim 1 wherein the utility module is in the form of one of a kitchen, a bench, a toilet and other utilities arrangement.

6. The unit of claim 1 wherein the utility module includes a structural support to support a person when the person steps on the utility module to access the accommodation space of the unit.

7. The unit of claim 1 wherein the lowering mechanism can be performed using a motor.

8. A system for a vehicle including an accommodation unit having an internal accommodation space, the system comprising:
a utility module; and
a motorized lowering mechanism coupled to both the accommodation unit and the utility module, the motorized lowering mechanism adapted to transition the utility module between an elevated, stored position within the internal accommodation space and a lowered, in-use position outside the internal accommodation space.

9. The system of claim 8 wherein the motorized lowering mechanism comprises wire ropes and guide tracks configured to raise and lower the utility module.

10. The system of claim 8 wherein the motorized lowering mechanism is configured to hold the utility module in the elevated, stored position with an upper surface of the utility module proximate a roof of the accommodation unit.

11. The system of claim 8 wherein the motorized lowering mechanism is configured to transition the utility module to the in-use position outside of the internal accommodation space such that the utility module rests on a ground surface.
